(19) United States
(12) Patent Application Publication
(10) Pub. No.: US 2003/0105690 A1
(43) Pub. Date: Jun. 5, 2003

(54) Method and apparatus for establishing and administering a charitable gift transfer plan

(75) Inventors: Michael D. Brown, Irvine, CA (US); Jonathan G. Blattmachr, Garden City, NY (US)

Correspondence Address: Bernard L. Kleinke, Foley & Lardner, 23rd Floor, 402 West Broadway, San Diego, CA, 92101-3542, US

(73) Assignee: Spectrum Group Investments, LLC

(21) Appl. No.: 10/043,988

(22) Filed: Jan. 9, 2002

Related U.S. Application Data
(60) Provisional application No. 60/337,758, filed on Dec. 3, 2001.

(51) Int. Cl. G06F 17/60

(52) U.S. Cl. 705/35; 705/1

(57) ABSTRACT

A system and method for the efficient transfer of a gift to a charity is disclosed. One embodiment of the system and method implements a charitable gift transfer plan comprising causing the issuance of common and preferred shares from a business entity such as a limited liability company. The common shares are then donated to the charity. A life insurance policy and a single-premium immediate annuity are purchased through the business entity. The purchases may be funded through a loan from a lender company. The payments from the annuity may be partially used to pay the interest on the loan, with the remainder being directed to the charity through the business entity. The death benefit of the life insurance policy is assigned to the owner of the preferred shares and may be used to retire the loan upon the death of the insured.

### FIELD OF THE INVENTION

The present invention relates in general to a method and apparatus for implementing and administering a charitable gift transfer plan. It more particularly relates to a method and apparatus for implementing and administering such a plan, which would generate cash flow periodically for selected charities, and provide possible charitable tax deductions for a customer.

### BACKGROUND ART

There have been many different types and kinds of systems for implementing financial plans. For example, reference may be made to the following U.S. Pat. Nos. 3,634,669; 4,648,037; 5,191,522; 5,214,579; 5,231,571; 5,233,514; 5,429,506; 5,631,828; 5,761,441; 5,819,230; 5,933,815; 5,966,693; 5,999,917; 6,018,714; 6,064,969; 6,161,096. However, they are not specifically related to the establishment and administration of charitable gift transfer plans. In this regard, it would be highly desirable to have a new and improved technique for transferring charitable gifts in a highly efficient and effective manner. The plan should be able to generate periodic cash flow to selected charities, and a customer should be able to receive charitable tax deductions in a highly efficient and cost effective manner.

### DESCRIPTION OF THE DRAWINGS

FIG. 1 is a flow chart diagram of a portion of the method for establishing and administering a charitable gift transfer plan; and

FIG. 2 is a hardware block diagram of a system for establishing and administering the charitable gift transfer plan.

### DETAILED DESCRIPTION OF PREFERRED EMBODIMENTS

The method and apparatus for establishing and administering a charitable gift transfer plan employs the use of a life insurance policy as a financial instrument for arbitrage opportunities involving life insurance, single-premium immediate annuities (SPIA), and premium financing. This arrangement may be referred to as a “life expectancy collar,” where the customer may buy and sell his or her life expectancy with a guaranteed outcome.

The plan may utilize the life insurance available for a customer to generate cash flow for selected charities and a charitable tax deduction for the customer. The concept of the plan relates to the use of a life insurance-annuity arbitrage, which includes the following: (1) a customer may borrow premium for both an SPIA and a life insurance policy, (2) the SPIA may produce life-long income to pay the loan interest, and (3) the life insurance may provide a death benefit that repays the lender.

For most insureds over a certain age such as age 60, this strategy may produce highly desirable results. Currently, for example, a preferred male, age 70, who may borrow $10 million may pay about $5 million in SPIA premium and about $5 million in life insurance premium. The SPIA purchased may produce approximately $580,000 annual income for life.

The life insurance may have a face amount of, for example, between about $15 million and about $20 million with conservative assumptions. At death, the life insurance may pay off the loan principal of $10 million, leaving between about $5 million and about $10 million of excess death benefit. The cost of the plan may be the loan interest (net of tax effects) less the income from the SPIA (net of tax effects). Current loan rates are such that a transaction may produce positive cash flow during life as well as a net death benefit greater than the total loan amount.

For example, where the total amount borrowed is $18 million, $5 million of the borrowed funds may be required to pay life insurance premiums. The remaining $13 million may be used for SPIA premium producing lifetime income of approximately $1.5 million each year. A 5% interest cost on the loan may be approximately $900,000 annually. The SPIA may produce lifetime income of $600,000 each year in excess of the annual loan interest. The positive cash flow of $600,000 each year, if given to the charity, may represent a gift of about $13 million over 20 years.

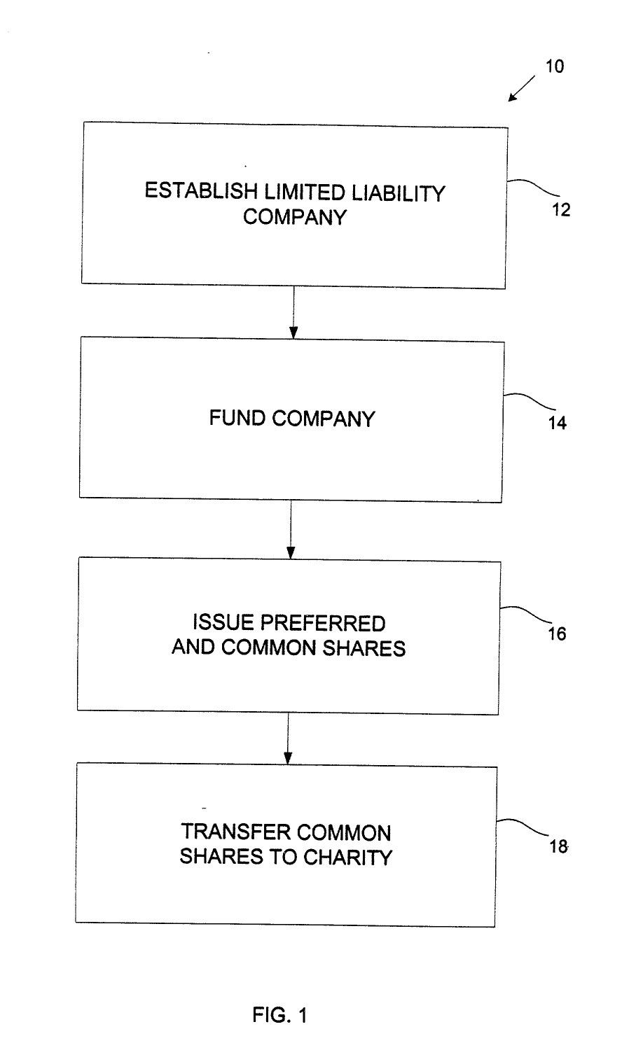

Referring now to the drawings, and more particularly to FIG. 1 thereof, the first step in the method 10 as indicated at block 12 may be to form a limited liability company (LLC) that may be funded to purchase an SPIA and a life insurance contract, as indicated at block 14. The LLC may be funded with liquid assets from the customer. As indicated at block 16, the LLC may issue both preferred and common shares, and transfer them to the customer. The customer may receive preferred shares that may have distributions equal to (LIBOR+1.5%)×0.55. With LIBOR at 3%, the distribution may be about 2.5% for life, or about $500,000 annually for 20 years.

The customer may also receive common shares or units in the LLC, which may distribute the excess cash flow from the life expectancy collar. The $18 million example may have common units valued at approximately $13 million, calculated based upon the positive cash flow provided at current interest rates of $1,000,000 annually.

The customer may immediately transfer the common interests to the charity as indicated at block 18. Since the customer's tax basis may be $13 million, the charitable deduction may reduce taxable income up to 50% of the customer's adjusted gross income (AGI). Depending on the customer's effective tax bracket, the deduction may reduce the customer's tax liability by between about $4 million and about $6 million.

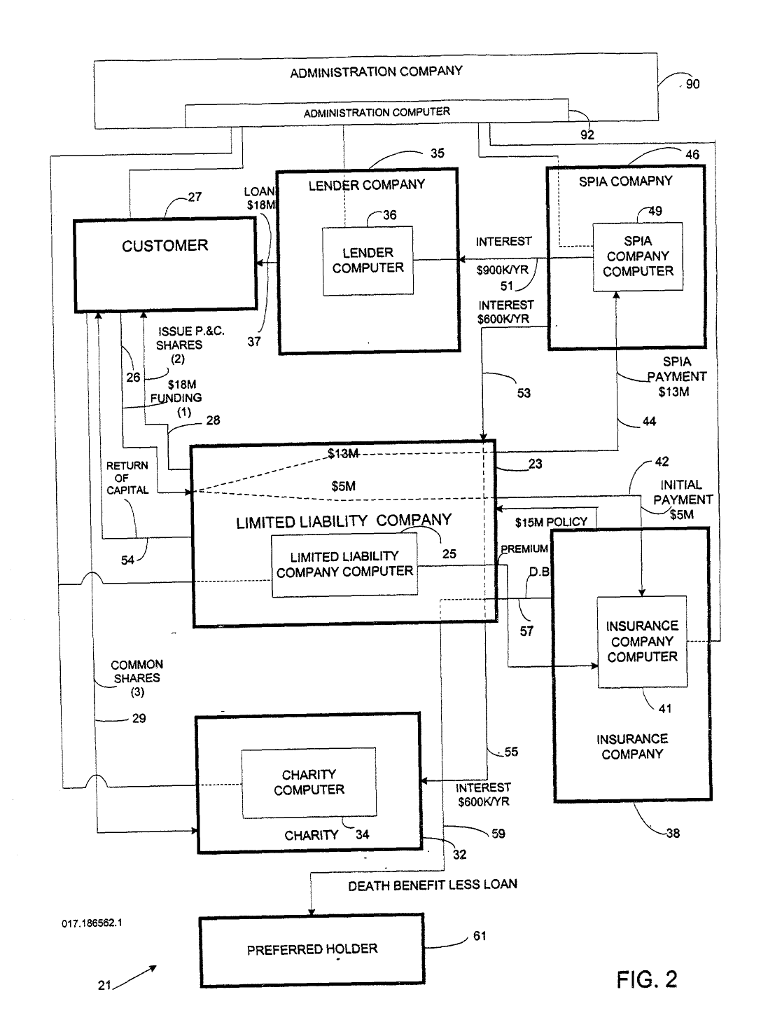

Referring now to FIG. 2, there is shown a system 21 for establishing and administering the charitable gift transfer plan according to one embodiment of the present invention. The system 21 includes a limited liability company 23 having a limited liability company computer 25 which is used to monitor the operations of the company 23 to facilitate the operation of the plan. In other embodiments of the invention, the limited liability company 23 may be replaced with another type of business entity, such as a corporation, for example.

As illustrated in FIG. 2, a plan administration company 90 may be employed to establish, maintain and administer the plan. The plan administration company 90 includes an administration computer 92 for communication with various other entities involved in the plan. In this regard, the administration computer 92 may initiate one or more steps of the plan by transmitting a message with instructions to one or more of the other entities.

A customer 27 may initially fund the limited liability company 23, as indicated at line 26. In this regard, the customer 27 may transmit a message including a fund transfer to the limited liability company computer 25. In other embodiments, the initial funding may be accomplished by the customer 27 via a bank or other financial institution.

Thereafter, the limited liability company 23 may issue both preferred and common shares to the customer 27, as indicated at line 28. In this regard, the transfer of shares may be recorded within the limited liability company computer 25, and a message may be sent from the limited liability company computer 25 to the customer 27.

As indicated at line 29, the customer 27 may then transfer his or her common shares to a charity 32 having a charity computer 34 for monitoring the operations of the charity 32. In this regard, the customer 27 may transmit a message to the charity computer 34 including the transfer of the shares. Additionally, the customer 27 may transmit a message to the limited liability company computer 25 notifying it of the change in ownership of the shares.

A lender company 35 having a lender company computer 36 may loan the initial amount of the funding to the customer 27 as indicated at 37. In this regard, the customer 27 may request a loan by transmitting a message or an application to the lender company 35 or its computer 36. The lender company computer 36 may then transmit a message including the fund transfer to the customer 27.

In the example illustrated in FIG. 2, the lender company 35 initially makes a loan to the customer 27 in the amount of $18 million dollars. As indicated at line 26, the funding of $18 million dollars may then be dispersed accordingly. In this regard, the customer may transmit a message including the fund transfer to the limited liability company computer 25.

The funds are then distributed by the limited liability company as required by the plan.

In this regard, in the present example, $5 million dollars of the funding is paid to an insurance company 38 having a computer 41 for monitoring its insurance business as indicated at line 42. The payment to the insurance company 38 may be performed by transmitting a message including the fund transfer from the limited liability company computer 25 to the insurance company computer 41. Alternatively, the funds may be transferred directly from the customer 27 on behalf of the limited liability company 23 to the insurance company computer 41.

As indicated at line 44, a remaining portion of the funding of the limited liability company 23 in the amount of $13 million dollars in the present example is paid to an SPIA company 46 having an SPIA company computer 49 for monitoring its business. In this regard, a message including a fund transfer is transmitted from the limited liability company computer 25 to the SPIA company computer 49. Alternatively, the funds may be transferred directly from the customer 27 on behalf of the limited liability company 23 to the SPIA company computer 49.

The payment is used to establish an SPIA which can generate interest payments which are sent from the SPIA company computer 49 to the lender computer 36 as indicated at line 51 to pay the interest on the loan to the customer 27. The funds may be transferred from the SPIA on a regular basis such as annually by the transmission of a message from the SPIA company computer 49 to either the lender computer 36 or the customer 27.

As indicated at line 53, additional interest, in the amount of $600,000 per year in the present example, is paid by the SPIA company 46 to the limited liability company 23, which in turn pays the interest to the charity 32 as indicated at 55. In this regard, the SPIA company computer 49 may transmit a message including a fund transfer to the limited liability company computer 25, which may relay the message including the fund transfer to the charity computer 34. Alternatively, the SPIA company computer 49 may transmit the message directly to the charity computer 34 on behalf of the limited liability company 23.

Assuming a competitive lending rate of LIBOR+1.5%, the customer may borrow the $18 million and purchase investment, business or passive assets. If the interest is deductible, the cost may be approximately (LIBOR+1.5%)×0.55 or the projected rate of annual distribution from the preferred limited liability company shares. Under special income allocation of the limited liability company, the taxable portion of the SPIA may be allocated to the charity and the customer may be allocated the “return of principal portion,” as indicated at line 54, for tax purposes.

This plan may continue through the life expectancy of the customer 27. If the customer 27 were to live beyond life expectancy (20 years in the present example), the SPIA payments may become fully taxable. After that time, the distribution on the preferred units may increase to become fully taxable. Thereafter, the distribution on the preferred units may increase to LIBOR+4.5%, to offset the increased tax cost of the plan. The initial income tax deduction may never be recaptured.

At the death of the customer 27, the life insurance death benefit may be distributed from the limited liability company to a preferred share holder 61, who may be the spouse, for example, of the customer 27, and who received the preferred shares either directly from the limited liability company or via a gift or a will from the customer. As indicated at line 57, the death benefit may be paid to the limited liability company 23, which in turn pays the death benefit less the payment for the loan to the preferred holder as indicated at 59. The remainder of the death benefit is paid to the lender company 35 by the limited liability company 23 to retire the loan.

In another embodiment of the invention, the life insurance may be owned individually and may not be a part of the limited liability company 23. In yet another embodiment, the life insurance is paid to the heirs of the customer via a life insurance trust or splitdollar arrangement.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A method of transferring a gift to a charity, comprising:
causing a business entity to issue common shares and preferred shares to a gift donor;
causing said gift donor to transfer said common shares to a charity;
causing said business entity to purchase an insurance policy from an insurance seller on the life of an insured individual;
causing said business entity to purchase an annuity from an annuity seller, said annuity generating a regular payment; and
allocating at least a portion of said regular payment to said charity.

2. The method according to claim 1, further comprising:
causing said gift donor to borrow a loan from a lender, funds from said loan being for the purchase of said annuity and said insurance policy.

3. The method according to claim 2, wherein at least a portion of said regular payment is allocated to interest on said loan.

4. The method according to claim 1, wherein said business entity is a limited liability company.

5. The method according to claim 1, wherein said business entity is a corporation.

6. The method according to claim 1, wherein a death benefit of said insurance policy is assigned to a holder of said preferred stock.

7. A system of transferring a gift to a charity, comprising:
means for causing a business entity to issue common shares and preferred shares to a gift donor;
means for causing said gift donor to transfer said common shares to a charity;
means for causing said business entity to purchase an insurance policy from an insurance seller on the life of an insured individual;
means for causing said business entity to purchase an annuity from an annuity seller, said annuity generating a regular payment; and
means for allocating at least a portion of said regular payment to said charity.

8. The system according to claim 7, further comprising:
means for causing said gift donor to borrow a loan from a lender, funds from said loan being for the purchase of said annuity and said insurance policy.

9. The system according to claim 8, wherein at least a portion of said regular payment is allocated to interest on said loan.

10. The system according to claim 7, wherein said business entity is a limited liability company.

11. The system according to claim 7, wherein said business entity is a corporation.

12. The system according to claim 7, wherein a death benefit of said insurance policy is assigned to a holder of said preferred stock.

13. A program product, comprising machine readable program code for causing a machine to perform the following method steps:
causing a business entity to issue common shares and preferred shares to a gift donor;
causing said gift donor to transfer said common shares to a charity;
causing said business entity to purchase an insurance policy from an insurance seller on the life of an insured individual;
causing said business entity to purchase an annuity from an annuity seller, said annuity generating a regular payment; and
allocating at least a portion of said regular payment to said charity.
